(19) United States
(12) Patent Application Publication
(10) Pub. No.: US 2017/0293282 A1
(43) Pub. Date: Oct. 12, 2017

(54) NUMERICAL CONTROLLER

(71) Applicant: FANUC CORPORATION, Minamitsuru-gun (JP)

(72) Inventors: Rie Oota, Minamitsuru-gun (JP); Mamoru Kubo, Minamitsuru-gun (JP); Koichi Murata, Minamitsuru-gun (JP)

(73) Assignee: FANUC CORPORATION, Minamitsuru-gun (JP)

(21) Appl. No.: 15/477,641

(22) Filed: Apr. 3, 2017

(30) Foreign Application Priority Data
Apr. 7, 2016 (JP) 2016-077131

(51) Int. Cl. G05B 19/18; G05B 19/4069; G06F 3/0482; G05B 19/409; G05B 19/418

(52) U.S. Cl. CPC G05B 19/18; G05B 19/409; G05B 19/41865; G06F 3/0482; G05B 19/4069; G05B 2219/36142; G05B 2219/35287

(57) ABSTRACT

A numerical controller provided with a function of registration and management of an application and capable of coping with a case in which necessary operation is changed in accordance with a situation, includes an application manager which registers the application to an operation process and manages an operation state and the present operation process among the operation process, and a menu display application which executes display control of a screen based on the operation state of the application acquired from the application manager. The application manager outputs a notification of start of the operation process to the application when the operation process is started, instructs the menu display application to emphasize and display the application when receiving a notification of a request of input of a user from the application, and advances the operation to the next operation process when all applications registered to the present operation process are completed.

### BACKGROUND OF THE INVENTION

### 1. Field of the Invention

The present invention relates to a numerical controller, in particular relates to a numerical controller which improves a production process.

### 2. Description of the Related Art

In a processing site, processing operation may be performed based on a way of thinking of a quality improvement cycle such as a PDCA cycle. The PDCA cycle is one of methods to smoothly carry out management operation such as production management and quality management in a business activity, and it is characterized in that the operation is continuously improved by repeating four steps of Plan→Do→Check→Act. In this way of thinking, a user in the processing site performs a series of operation of processing provision, processing and measurement, and the user performs an approach for further improvement to figure out problems. With this, improvement in quality of a processed product can be smoothly performed.

Further, in recent years, in addition to an original function for numerical control, an application which supports whole processing is often installed into a numerical controller. Thus, a menu display which facilitates easy access to each application is adopted. As the numerical controller provided with a menu display function in conventional art, for example, JP 2008-217045 A discloses a numerical controller in which menu items (icons) for respective applications are categorized so that a user can find the menu item (icon) to be used in each situation in a processing process.

In a case in which the quality improvement cycle is adopted to operation in the processing site, a user performs the operation in accordance with the cycle. In such a case, it is necessary that the user performs the operation based on the order in the cycle. However, the operation might be changed in connection with a result or a situation after other operation is performed. For example, in a case in which replacement timing of a maintenance part in a processing machine or the like is come during the operation in the processing site, it is necessary to review a processing schedule and to stop the operation in order to ensure time for the replacement of the maintenance part.

In this way, in a case in which operation different from the normal routine is occurred, it might be difficult for a user, who is not used to perform the operation, to perform the operation in accordance with the order.

In the technique disclosed in JP 2008-217045 A, icon groups corresponding to the order of the operation processes are displayed, and when either of the icon is selected, an information setting screen corresponding to the process of the icon is displayed at the same time to make it possible to perform the operation in accordance with the order of the operation processes. However, although the technique disclosed in JP 2008-217045 A can be applied to a case in which the operation of the normal routine is performed, it cannot be applied to a case in which necessary operation is changed in accordance with a situation of the processing or the like.

### SUMMARY OF THE INVENTION

Accordingly, an object of the present invention is to provide a numerical controller provided with a function of registration and management of an application and capable of coping with a case in which necessary operation is changed in accordance with a situation.

The invention according to a first aspect of the present application is a numerical controller that manages at least one operation process and executes display control of an icon of an application along a flow of the operation process, the numerical controller including: an application manager configured to register at least one application to the operation process and configured to manage an operation state of the registered application and the operation process presently executed in the operation process; and a menu display application configured to execute display control of a screen based on the operation state of the application acquired from the application manager, wherein the application manager outputs a notification, which indicates that the operation process is started, to the application registered to the presently executed operation process, the application manager instructs the menu display application based on a notification of a request of input of a user sent from the application such that the application which sent the notification of the request of the input of the user is emphasized and displayed, and when the application manager receives a notification of completion of the operation from all of the applications registered to the presently executed operation process, the application manager determines that the presently executed operation process is completed and advances the presently executed operation process to the operation process to be executed after the presently executed operation process among the operation processes.

According to the present invention, in a case in which a user obeys a quality improvement cycle and necessary operation is changed in accordance with a situation, the user can grasp the timing for using an application, and thereby the user can perform the operation based on a process of quality improvement.

### BRIEF DESCRIPTION OF THE DRAWINGS

The above and other objects and features of the present invention will become apparent from the following detailed description of an embodiment made with reference to the accompanying drawings. In the drawings:

FIG. 1 is a view illustrating an image of a menu screen displayed on a display device of a numerical controller according to the present invention;

FIG. 2 is a schematic configuration view of hardware of the numerical controller according to one embodiment of the present invention;

FIG. 3 is a view schematically illustrating an execution state of an application in the numerical controller according to the one embodiment of the present invention;

FIG. 4 is a view illustrating an example of a menu definition file using a language with tag (XML);

FIG. 5 is a view illustrating a flow of operation of the numerical controller based on an operation process according to an example of the present invention;

FIG. 6 is a view illustrating the menu definition file according to the example of the present invention;

FIG. 7 is a view illustrating a display example of a menu screen according to the example of the present invention;

FIG. 8 is a view illustrating the menu screen in which a machining schedule setting application is emphasized according to the example of the present invention;

FIG. 9 is a view illustrating the menu screen in which an automatic operation application is emphasized according to the example of the present invention;

FIG. 10A is a view illustrating the menu screen in which the machining schedule setting application belonging to an operation process of improvement is emphasized (a menu item of a measurement application is emphasized) according to the example of the present invention;

FIG. 10B is a view illustrating the menu screen in which the machining schedule setting application belonging to the operation process of improvement is emphasized (a menu item of a maintenance application is emphasized) according to the example of the present invention; and

FIG. 11 is a schematic flowchart illustrating a flow of processing executed on an application manager according to the one embodiment of the present invention.

### DETAILED DESCRIPTION OF THE PREFERRED EMBODIMENTS

Hereinafter, an embodiment of the present invention is described with reference to drawings.

In the present invention, operation according to a numerical controller is provided with a plurality of operation processes (for example, three processes of a planning process, a machining process, and an improvement process) as a precondition, and both of a function which manages the operation process that a user is presently performing and a function which can register a plurality of applications which performs necessary operation in each operation process and display the application by each operation process are added to the numerical controller.

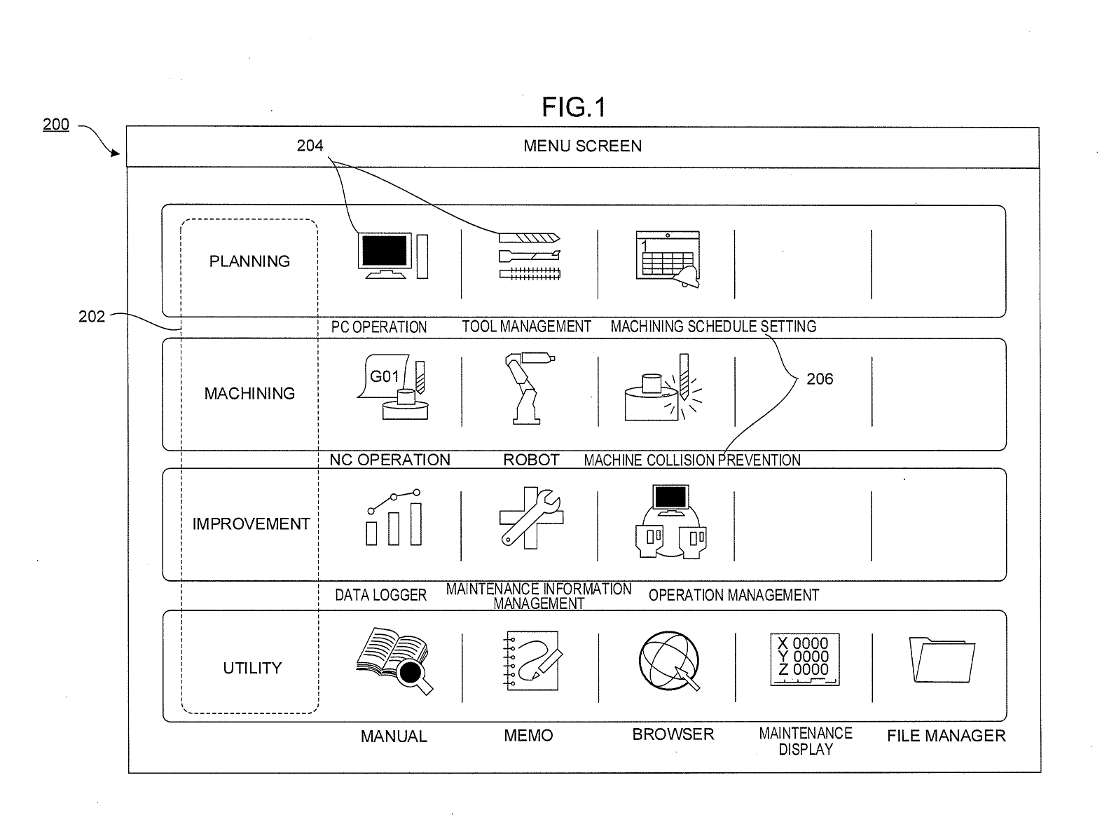

FIG. 1 is a view illustrating an example of an image of a menu screen displayed on a display device of the numerical controller according to the present invention. In a menu screen 200 illustrated in FIG. 1, each of PLANNING, MACHINING, IMPROVEMENT, UTILITY or the like in the numerical reference of 202 indicates the operation process (category), and menu items of each application registered to each operation process is displayed in the menu screen 200 by each category of operation items. In the menu screen illustrated in FIG. 1, each of the menu items is provided with an icon 204 and a caption 206, and when a user selects the menu item by operating an input device such as a keyboard and a mouse, an operation screen of each application is displayed on the display device and thereby operation of the user to the application can be received.

The numerical controller according to the present invention notifies the start of the operation process to the application registered to the operation process when each of the operation processes is started. In a case in which the application, which receives the notification, requires operation or input by a user, an icon which selects the application is emphasized and displayed as a selection target in the menu screen displayed on the display device of the numerical controller.

After that, when the numerical controller according to the present invention receives a notification of processing completion which is output when the application to which the start of the operation process is notified completes the execution of the processing necessary in the operation process and the numerical controller receives the notifications of the processing completion from all of the applications registered to the present operation process, the numerical controller notifies the start of the operation process to the application of the next operation process. Further, the numerical controller according to the present invention carries the operation processes forward by repeating the flow described above.

Hereinafter, a configuration of the numerical controller according to the present invention is described.

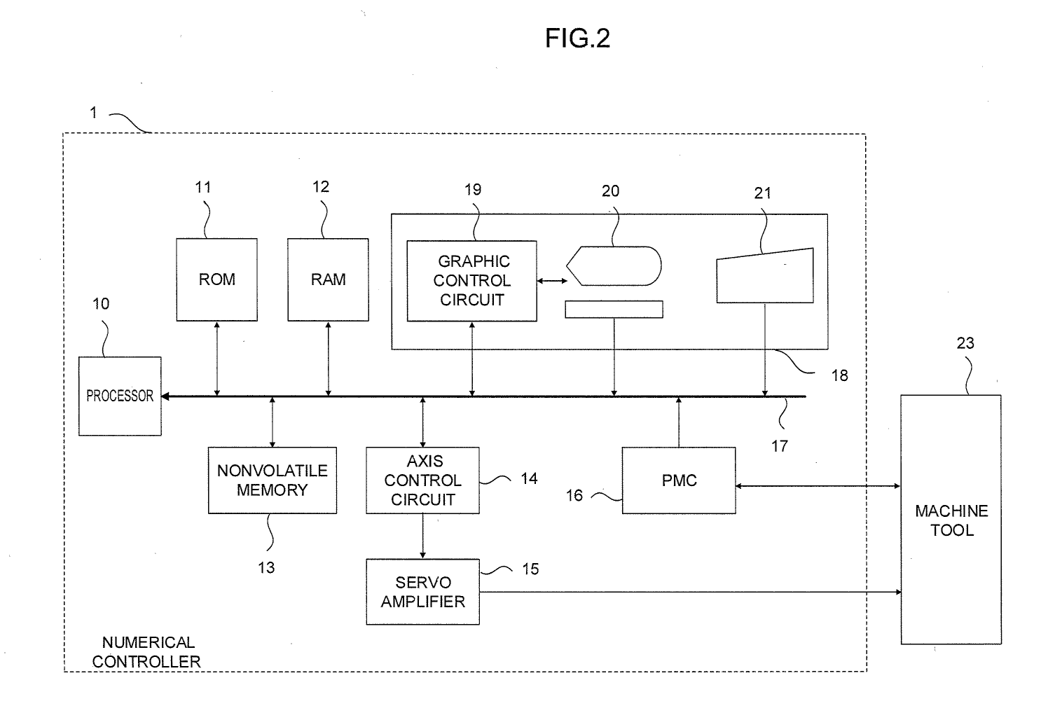

FIG. 2 is a schematic configuration view of hardware of the numerical controller according to the present embodiment. The numerical controller 1 is mainly provided with a processor 10. The processor 10 is formed to control a whole of the numerical controller 1 in accordance with a system program stored in a ROM 11. An EPROM or an EEPROM is used as the ROM 11. Further, the system program includes a program of an application manager described below, a program of a menu display application, and the like.

A DRAM is used as a RAM 12, and temporary calculation data, various flags, display data, an input output signal and the like are stored therein. A CMOS or a SRAM backed-up by a not shown battery is used as a nonvolatile memory 13, and a parameter, a processing program, tool correction data and the like to be held after the power supply is interrupted are stored therein. Further, a menu definition file, an execution program for various applications and the like are also stored in the nonvolatile memory 13.

A LCD/MDI unit 18 is arranged on a front face of the numerical controller 1 or at the same position as a machine operation panel, and the LCD/MDI unit 18 is used for display of data or figures, data input, operation of the numerical controller 1.

A graphic control circuit 19 converts a digital signal of numerical data, figure data and the like into a raster signal for display, and the graphic control circuit 19 sends the raster signal to a display device 20. The display device 20 displays the numerical value and the figure. A liquid crystal display device is mainly used as the display device 20.

An input device 21 includes a keyboard provided with a numerical key, a symbolic key, a character key and a function key, a mouse, a touch panel and the like, and the input device 21 is used for generating and editing of a processing program or a menu definition file and for operation of the numerical controller.

In a case in which the menu screen is displayed on the display device 20, the menu item can be selected via the touch panel arranged as the input device 21 so as to be laminated with the display device. The function selected by operating the touch panel is changed in accordance with the menu screen displayed on the display device.

A axis control circuit 14 receives a movement instruction of a axis from the processor 10 and outputs the movement instruction of the axis to a servo amplifier 15. The servo amplifier 15 amplifies the movement instruction and drives a servo motor joined to a machine tool 23 and thereby the servo amplifier 15 controls relative movement between a tool of the machine tool 23 and a work. Further, although one axis is illustrated in the figure, the axis control circuit 14 and the servo amplifier 15 are arranged so as to correspond to the number of the axes of the servo motors.

A PMC (Programmable Machine Controller) 16 receives an M (auxiliary) function signal, an S (spindle speed control) function signal, a T (tool selection) function signal and the like from the processor 10 via a bus 17. Further, the PMC 16 processes these signals by using a sequence program and outputs an output signal and controls an air pressure device, an oil pressure device, an electromagnetic actuator or the like in the machine tool 23. Further, the PMC 16 receives a signal of a button, a signal of a switch, and a signal of a limit switch or the like of the machine operation panel in the machine tool 23 and the PMC 16 performs sequence processing and transfers a necessary input signal to the processor 10 via the bus 17.

Further, in FIG. 2, illustrations of a spindle motor control circuit, a spindle motor amplifier and the like are omitted.

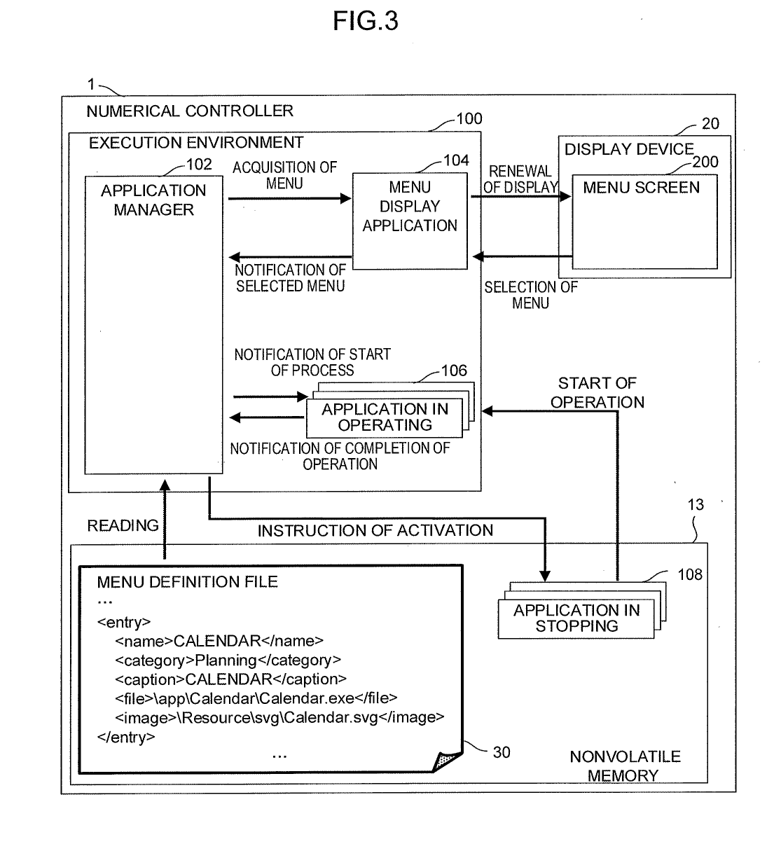

FIG. 3 is a view schematically illustrating an execution state of the application in the numerical controller 1 according to the present embodiment. Hereinafter, more detailed operation of the numerical controller 1 according to the present invention is described with reference to FIG. 3.

### <Procedure 1> To Register Menu Items to an Application Manager

In the numerical controller 1, an application manager 102, a menu display application 104, and various applications are executed on an execution environment 100 for executing the program prepared by the OS or the like. The application manager 102 is formed to perform register and management of each application 106 used in the operation process. The application manager 102 is read to the execution environment 100 automatically in accordance with the setting of the OS after the numerical controller 1 is activated, and then the operation of the application manager 102 is started. The application manager 102 reads a menu definition file 30 which defines the menu items when the operation of the application manager 102 is started.

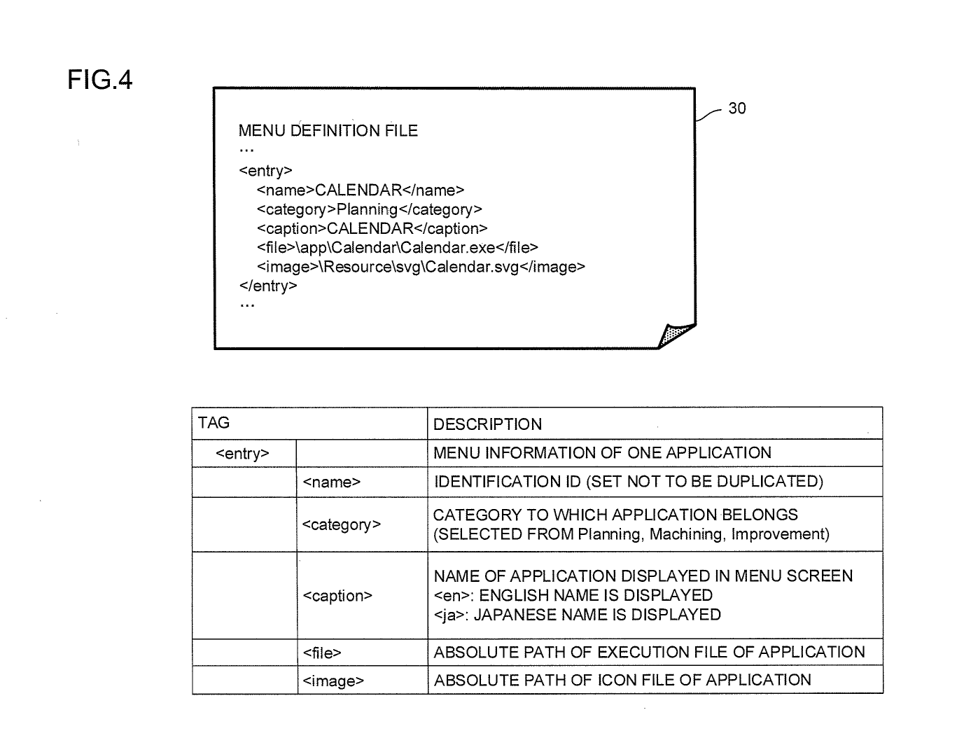

FIG. 4 is a view illustrating an example of a definition of the menu definition file 30 using a language with tag (XML). In the example illustrated in FIG. 4, a plurality of menu information of the application is described in the menu definition file 30, and the menu information of each application includes an identification ID which is able to identify the application unambiguously, a category of the operation process to which the application is to belong (for example, planning, machining, improvement, or the like), a name of the application to be displayed in the menu screen, a file path in which the execution file of the application is located. Further, in some cases, the menu information of each application may include a file path in which an icon file of the application is located, a current folder path where the application is executed, or the like.

After the application manager 102 reads the menu definition file 30, the application manager 102 manages the applications based on the menu information of each application described in the menu definition file 30 such that each application is registered to belong to each category (operation process). The application manager 102 executes inter-application communication between a menu display application 104, which displays the menu screen, executed on the execution environment 100 and an application 106, and the application manager 102 performs notifying to each application and acquiring information from each application. A method of the inter-application communication may be used a well-known method such as a window message, a shared memory or the like.

### <Procedure 2> To Display the Menu Items

The menu display application 104 acquires menu information of all of the applications 106 from the application manager 102. The menu information includes an identification ID of the application, a caption of the application, a category of the operation process to which the application belongs, a flag indicating whether the display of the menu item is emphasized. Further, in some cases, the menu display information may include a file path of the icon or the like.

The menu display application 104 forms the caption by every category of the operation process to which the application belongs and, in some cases, forms display of the menu item formed by the icon, and the menu display application 104 displays a menu screen 200 on the display device 20. In a case in which the flag indicating whether the display of the menu item is emphasized is ON, the menu display application 104 executes emphasis display in which the caption or a color of the icon of the menu item is change, the displayed menu item size is enlarged, or the like.

In a case in which the menu item is selected on the menu screen 200, the menu display application 104 notifies the identification ID of the application of the selected menu item to the application manager 102 and the menu display application 104 requests the application manager 102 to activate the application 106. Further, in a case in which the application corresponding to the identification ID is already activated, the menu display application 104 requests the application manager 102 that a user can operate (activate) the application.

### <Procedure 3> To Manage the Operation Process

The application manager 102 holds a flag relating to which process of the planning, the machining, the improvement or the like the present operation process is, and a flag relating whether the processing to each application 106 is executed. When the present operation process is changed, the application manager 102 notifies the start of the operation process to the application 106 which belongs to the present operation process (after the application is activated as necessary). The application 106 executes the processing after receiving the notification of the start of the operation process. Further, after the application 106 executes the processing, the application 106 notifies the processing completion to the application manager 102. When the application manager 102 receives the processing completion of all of the applications 106 which execute the processing belonging to the present operation process, the application manager 102 changes the present operation process to the next operation process.

### <Procedure 4> In a Case in Which Input of a User is Necessary

In a case in which the input of a user is necessary when the application 106 executes the processing, the application 106 executes notification of a request of the input of the user to the application manager 102. When the request of the input of the user is notified, the application manager 102 changes the flag relating to whether the menu item of the menu information of the application 106 as a notification source is emphasized to ON, and the application manager 102 notifies a request of renewal of the menu item to the menu display application 104. When the menu display application 104 receives the notification of the renewal request of the menu item, the menu display application 104 reacquires the menu information from the application manager 102 and displays the menu item on the menu screen 200 based on the reacquired menu information. When the application manager 102 receives the notification of the input completion of the user or the notification of the processing completion from the application 106, the application manager 102 changes the flag for emphasizing the menu item of the menu information into OFF, and the application manager 102 notifies a request of renewal of the menu item to the menu display application 104. When the menu display application 104 receives the notification of the renewal request of the menu item, the menu display application 104 reacquires the menu information from the application manager 102 and displays the menu item on the menu screen 200 based on the reacquired menu information.

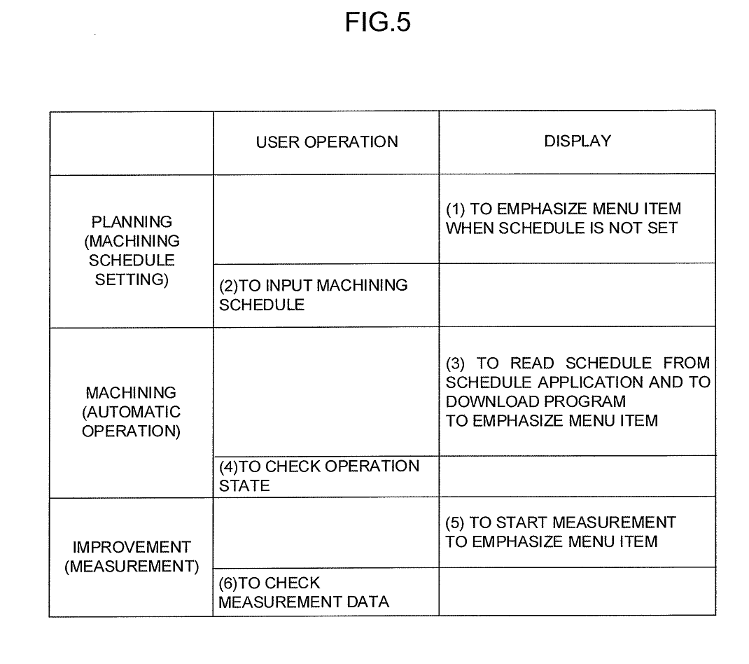

Next, an example of display of the actual menu based on the procedures described above is described with reference to FIG. 5 through FIGS. 10A and 10B.

FIG. 5 illustrates a flow of operation of the numerical controller based on the operation process according to the present example.

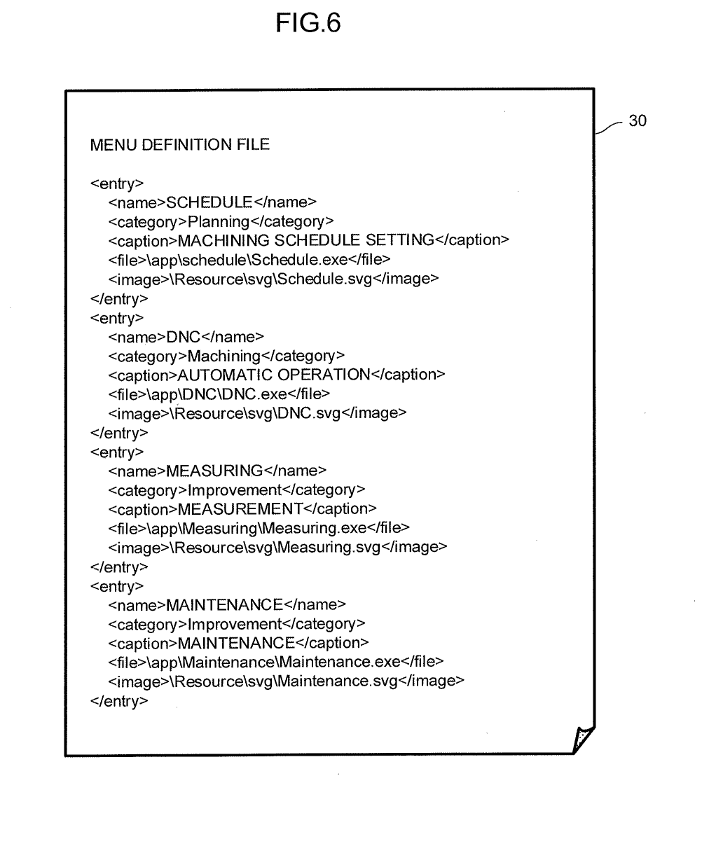

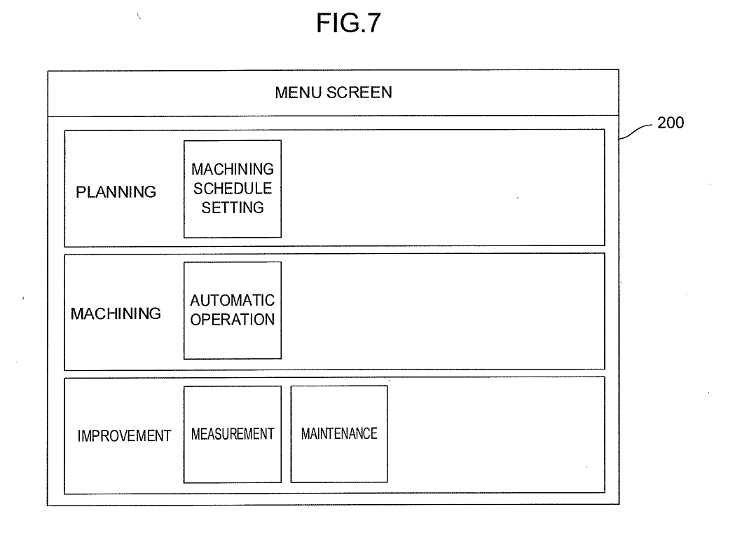

When the application manager 102 reads the menu definition file 30 illustrated in FIG. 6 as an example, a machining schedule setting application is registered to the operation process of Planning, an automatic operation application is registered to the operation process of Machining, and a measurement application and a maintenance application are registered to the operation process of Improvement, respectively. Further, the menu display application 104 acquires the menu information of the registered application from the application manager 102, and the menu display application 104 displays the menu screen 200 illustrated in FIG. 7 on the display device based on the acquired menu information.

The application manager 102 sets the present operation process to be the operation process of Planning by internal processing, and the application manager 102 sets the flag indicating whether the processing of all of the applications belonging to the operation process of Planning was executed to be OFF. Further, the application manager 102 notifies the start of the operation process to a machining schedule setting application which is an application belonging to the operation process of Planning.

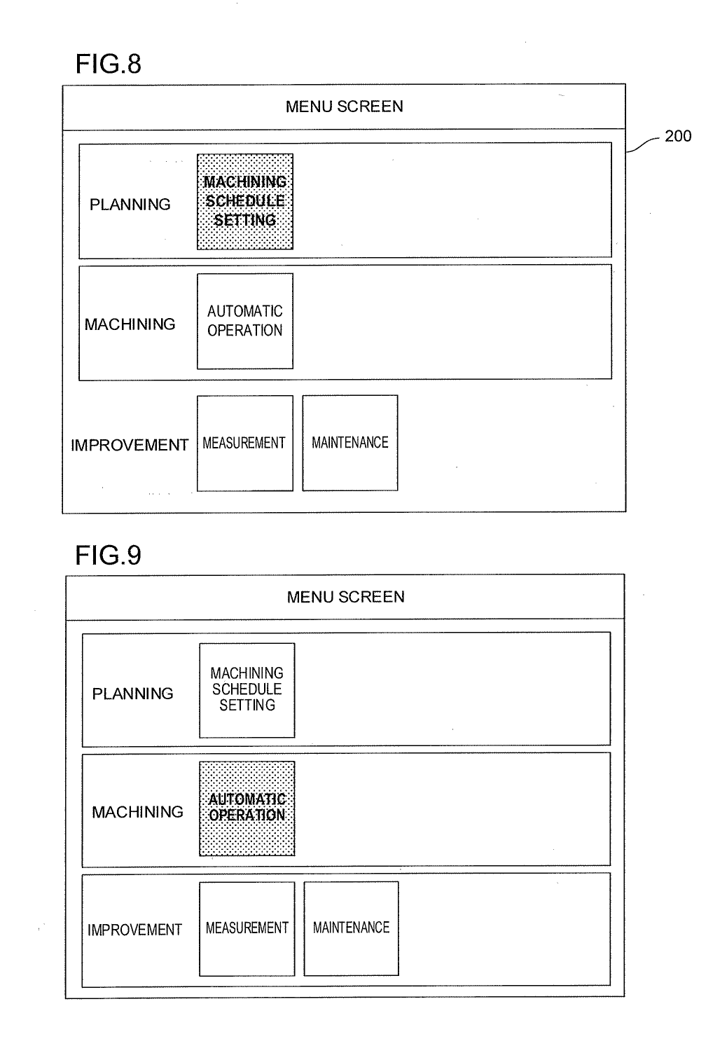

The machining schedule setting application to which the start of the operation process is notified acquires, for example, machining schedule information from a schedule management server or a personal computer which is provided as a master unit or the like connected via a network. In a case in which the machining schedule setting application cannot acquire the machining schedule information, the machining schedule setting application requests the input of the user to the application manager 102, and as illustrated in FIG. 8, the menu item is emphasized in order to urge the user to set the machining schedule information ((1) in FIG. 5). When the machining schedule setting application acquires the machining schedule or the machining schedule is set ((2) in FIG. 5), the machining schedule setting application checks the operation state based on information acquired from each part of the numerical controller 1. Further, when the machining schedule setting application confirms that the operation according to the machining is started, the machining schedule setting application notifies the completion of the processing to the application manager 102 (“a flag indicating whether the processing of the application was executed” of the machining schedule setting application is switched to ON).

Since the processing of all of the applications registered to the operation process of Planning is completed (“the flag indicating whether the application was executed” relating to all of the applications is switched to ON) at this moment, the application manager 102 determines that the operation process of Planning is completed and changes the present operation process to the operation process of Machining by the internal processing. Further, the application manager 102 sets the flag indicating whether the processing of all of the applications belonging to the operation process of Machining was executed to be OFF, and the application manager 102 notifies the start of the process to all of the applications belonging to the operation process of Machining.

In a case in which check of a user is necessary, the automatic operation application belonging to the operation process of Machining requests the input of the user to the application manager 102, and as illustrated in FIG. 9, the menu item is emphasized in order to urge the user to check the necessary item ((3) in FIG. 5). The automatic operation application checks the operation state based on information acquired from each part of the numerical controller 1 ((4) in FIG. 5), and in a case in which the operation state is in a stopping state, the automatic operation application notifies the completion of the processing to the application manager 102 (“a flag indicating whether the processing of the application was executed” of the automatic operation application is switched to ON).

Since the processing of all of the applications registered to the operation process of Machining is completed (“the flag indicating whether the application was executed” relating to all of the applications is switched to ON) at this moment, the application manager 102 determines that the operation process of Machining is completed and changes the present operation process to the operation process of Improvement by the internal processing. Further, the application manager 102 sets the flag indicating whether the processing of all of the applications (the measurement application, the maintenance application) belonging to the operation process of Improvement was executed to be OFF, and the application manager 102 notifies the start of the process to all of the applications belonging to the operation process of Improvement.

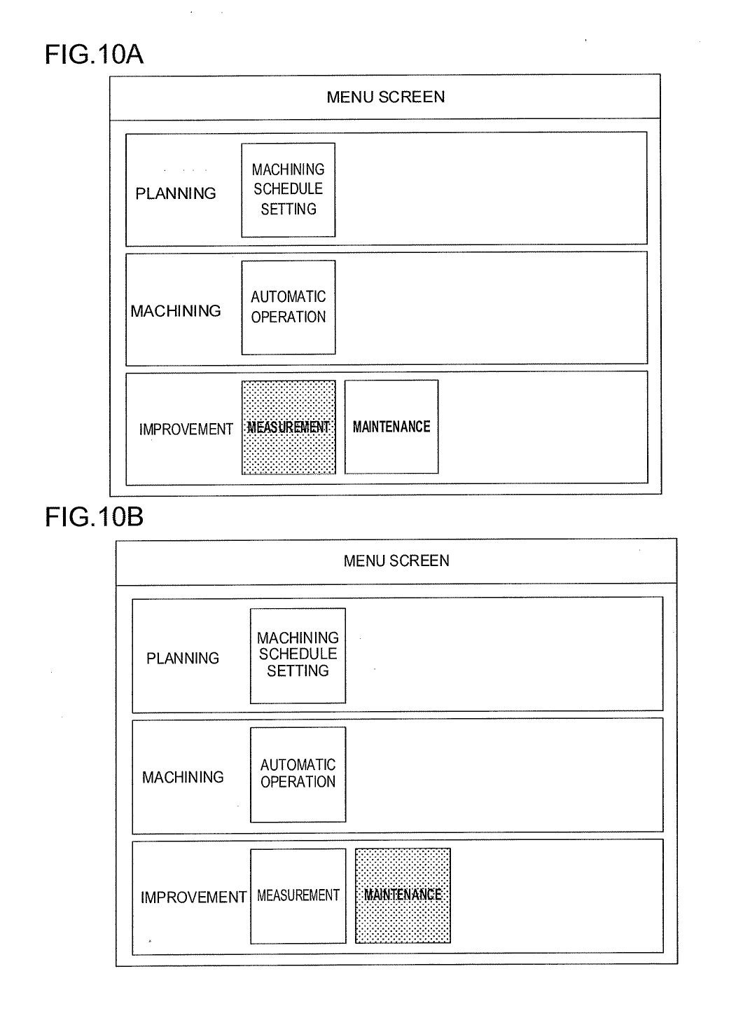

The measurement application belonging to the operation process of Improvement measures a processed product by controlling each device used for the measurement ((5) in FIG. 5), and after the measurement is completed, the measurement application checks a macro variable in which a measurement result of the processed product is held ((6) in FIG. 5). In a case in which the measurement result is necessary to be checked by a user (for example, in a case in which the measurement result is deviated largely from a predetermined target measurement value), the measurement application requests the input of the user to the application manager 102, and as illustrated in FIG. 10A, the menu item of the measurement application is emphasized in order to urge the user to check the necessary item ((5) in FIG. 5). After the check of the user is completed, the measurement application notifies the completion of the processing to the application manager 102 (“a flag indicating whether the processing of the application was executed” of the measurement application is switched to ON).

The maintenance application belonging to the operation process of Improvement monitors a PMC signal or the like and checks whether there is a machinery member whose lifetime is about to be expired. In a case in which the maintenance is necessary, the maintenance application requests the input of the user to the application manager 102, and as illustrated in FIG. 10B, the menu item of the maintenance application is emphasized in order to urge the user to check the necessary item. After the maintenance state becomes a normal state, the maintenance application notifies the completion of the processing to the application manager 102 (“a flag indicating whether the processing of the application was executed” of the maintenance application is switched to ON).

When the processing of all of the applications registered to the operation process of Improvement is completed (“the flag indicating whether the application was executed” relating to all of the applications is switched to ON), the application manager 102 determines that the operation process of Improvement is completed and changes the present operation process to the operation process of Planning by the internal processing.

By repeating the procedures described above, the numerical controller 1 carries the operation processes forward.

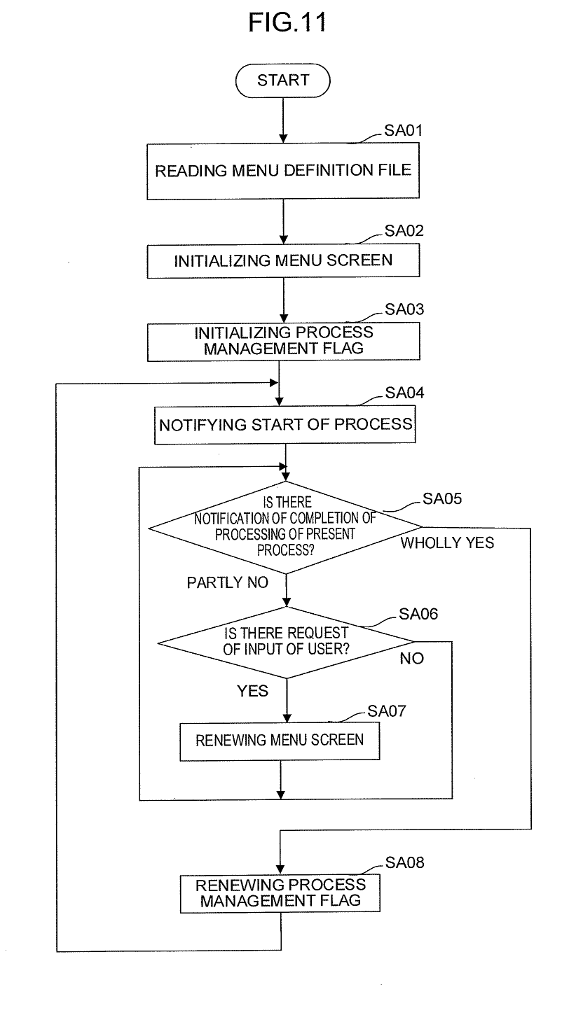

FIG. 11 is a flowchart illustrating operation of the application manager 102.

Step SA01: The application manager 102 reads the menu definition file 30 and registers the applications to the operation processes respectively based on contents described in the read menu definition file 30.

Step SA02: The application manager 102 outputs the menu information of the application registered to each of the operation processes to the menu display application 104, and the application manager 102 instructs the menu display application 104 to display the menu screen 200 on the display device.

Step SA03: The application manager 102 sets the flag indicating whether the processing of all of the applications belonging to the present operation process to be OFF.

Step SA04: The application manager 102 notifies the start of the operation process to all of the applications belonging to the present operation process.

Step SA05: The application manager 102 determines whether “the flag indicating whether the application was executed” of the application registered to the present operation process is switched to ON. In a case in which all of the flags are switched to ON, the processing proceeds to Step SA08, and in a case in which a part of the flags is not switched to ON, the processing proceeds to Step SA06.

Step SA06: The application manager 102 determines whether the input of the user is requested from the application. In a case in which the input of the user is requested from the application, the processing proceeds to Step SA07, otherwise the processing proceeds to Step SA05.

Step SA07: The application manager 102 instructs the menu display application such that the display of the corresponding application is emphasized based on the request of the input of the user from application, and the processing proceeds to Step SA05.

Step SA08: The application manager 102 switches the flag indicating whether the processing of all of the applications belonging to the next operation process was executed to OFF and advances the operation process to the next operation process, and the processing proceeds to Step SA04.

The embodiment of the present invention is described above, however the present invention is not limited to an example of the embodiment described above, and the present invention can be carried out by other aspect into which appropriate modification is applied.

1. A numerical controller that manages at least one operation process and executes display control of an icon of an application along a flow of the operation process, the numerical controller comprising:
an application manager configured to register at least one application to the operation process and configured to manage an operation state of the registered application and the operation process presently executed in the operation process; and
a menu display application configured to execute display control of a screen based on the operation state of the application acquired from the application manager, wherein the application manager outputs a notification, which indicates that the operation process is started, to the application registered to the presently executed operation process,
the application manager instructs the menu display application based on a notification of a request of input of a user sent from the application such that the application which sent the notification of the request of the input of the user is emphasized and displayed, and
when the application manager receives a notification of completion of the operation from all of the applications registered to the presently executed operation process, the application manager determines that the presently executed operation process is completed and advances the presently executed operation process to the operation process to be executed after the presently executed operation process among the operation processes.
